(19) United States
(12) Patent Application Publication
(10) Pub. No.: US 2025/0021081 A1
(43) Pub. Date: Jan. 16, 2025

(54) PRODUCTION CONTROL METHOD AND APPARATUS, AND ELECTRONIC DEVICE AND STORAGE MEDIUM

(71) Applicants: MIANYANG BOE OPTOELECTRONICS TECHNOLOGY CO.,Ltd., Mianyang, Sichuan (CN); BOE Technology Group Co., Ltd., Beijing (CN)

(72) Inventors: Haiyang TANG, Beijing (CN); Lang LIU, Beijing (CN)

(21) Appl. No.: 18/712,714

(22) PCT Filed: May 25, 2023
(86) PCT No.: PCT/CN2023/096149

§ 371 Date: May 23, 2024

(30) Foreign Application Priority Data
May 31, 2022 (CN) 202210615336.3

(51) Int. Cl. G05B 19/418; G06Q 10/20

(52) U.S. Cl. CPC G05B 19/4184; G06Q 10/20; G05B 2219/32234

(57) ABSTRACT

A production control method and apparatus, an electronic device and a storage medium are provided. The method includes: acquiring a first quantity of materials to be treated that correspond to a first process device, wherein said materials are target materials which have entered the first process device but have not entered a second process device, and the second process device is a process device in the next procedure after the first process device; on the basis of the current process state of the second process device, predicting a second quantity of target materials which can be treated by the second process device during a preset process duration corresponding to the first process device, wherein the second process device can process a fixed quantity of target materials in each working state; controlling a feeding action of the first process device according to the first quantity and the second quantity.

### CROSS-REFERENCE TO RELATED APPLICATIONS

The present application is a U.S. National Phase Entry of International Application PCT/CN2023/096149 having an international filing date of May 25, 2023, which claims priority to Chinese Patent Application No. 202210615336.3 filed to the CNIPA on May 31, 2022 and entitled “A Production Control Method and Related Device”, and the contents disclosed in the above-mentioned applications are hereby incorporated as a part of this application.

### TECHNICAL FIELD

Embodiments of the present disclosure relate to but are not limited to the field of production control, and in particular to a production control method and a device, an electronic device and a storage medium.

### BACKGROUND

In a process of production and processing, an assembly line workshop is composed of a plurality of process devices. After process treatment of a previous process device, materials passed through a previous process will be transferred to an adjacent subsequent process device by manipulators or other transfer devices to continue the process treatment. When production capabilities of devices in front and back processes do not match, a production efficiency of a whole production line will be significantly affected. Moreover, when a time difference between a previous process and a subsequent process is long, the materials that have been treated by the previous process are prone to environmental pollution in the workshop, thus reducing the production quality of products.

### SUMMARY

The following is a summary of subject matters described herein in detail. This summary is not intended to limit the protection scope of claims.

A series of concepts in simplified form are introduced into the Summary section, which will be described in further detail in the Detailed Description section. The Summary section of the present disclosure is not intended to attempt to limit key features and necessary technical features of the claimed technical scheme, nor to attempt to determine the scope of protection of the claimed technical scheme.

In a first aspect, an embodiment of the present disclosure provides a production control method including:
acquiring a first quantity of materials to be treated corresponding to a first process device, wherein the materials to be treated are target materials that have entered the first process device but have not entered a second process device, and the second process device is a process device in a next procedure after the first process device;
predicting a second quantity of target materials that can be treated by the second process device during a preset process duration corresponding to the first process device based on a current process state of the second process device, wherein the process state comprises a working state and a maintenance state;
controlling a feeding action to the first process device according to the first quantity and the second quantity.

Optionally, predicting the second quantity of target materials that can be treated by the second process device during the preset process duration corresponding to the first process device based on the current process state of the second process device includes:
determining a remaining process duration before maintenance based on a rated duration of a single piece process corresponding to the second process device, a remaining process capacity before maintenance and a processed duration of a current piece, wherein, the remaining process capacity before maintenance is a maximum quantity of target materials that the second process device can continue to treat before entering the maintenance state;
determining a remaining duration before ending maintenance according to the rated duration of the single piece process corresponding to the second process device, the remaining process capacity before maintenance, the processed duration of the current piece and a rated duration of maintenance;
predicting the second quantity of target materials that can be treated by the second process device during the preset process duration corresponding to the first process device according to the remaining process capacity before maintenance, the remaining process duration before maintenance, the remaining duration before ending maintenance and the preset process duration.

Optionally, predicting the second quantity of target materials that can be treated by the second process device during the preset process duration corresponding to the first process device according to the remaining process capacity before maintenance, the remaining process duration before maintenance, the remaining duration before ending maintenance and the preset process duration includes:
when the remaining process capacity before maintenance is equal to zero, acquiring a maintained duration corresponding to the second process device;
calculating the second quantity according to the preset process duration, the rated duration of maintenance, the maintained duration and the rated duration of the single piece process.

Optionally, predicting the second quantity of target materials that can be treated by the second process device during the preset process duration corresponding to the first process device according to the remaining process capacity before maintenance, the remaining process duration before maintenance, the remaining duration before ending maintenance and the preset process duration includes:
when the remaining process capacity before maintenance is not zero and the remaining process duration before maintenance is greater than the preset process duration, determining the second quantity according to the preset process duration, the rated duration of the single piece process and the processed duration of the current piece.

Optionally, predicting the second quantity of target materials that can be treated by the second process device during the preset process duration corresponding to the first process device according to the remaining process capacity before maintenance, the remaining process duration before maintenance, the remaining duration before ending maintenance and the preset process duration includes:
when the remaining process capacity before maintenance is not zero, the remaining process duration before maintenance is less than the preset process duration and the remaining duration before ending maintenance is greater than the preset process duration, determining that the remaining process capacity before maintenance is the second quantity.

Optionally, predicting the second quantity of target materials that can be treated by the second process device during the preset process duration corresponding to the first process device according to the remaining process capacity before maintenance, the remaining process duration before maintenance, the remaining duration before ending maintenance and the preset process duration includes:
when the remaining process capacity before maintenance is not zero, the remaining process duration before maintenance is less than the preset process duration and the remaining duration before ending maintenance is less than the preset process duration, determining the second quantity according to the preset process duration, the rated duration of the single piece process, the processed duration of the current piece and the rated duration of maintenance.

Optionally, predicting the second quantity of target materials that can be treated by the second process device during the preset process duration corresponding to the first process device based on the current process state of the second process device includes:
when the second process device includes at least two process chambers, respectively acquiring an current process state of each chamber;
determining a third quantity of target materials that can be treated by each of the process chambers during the preset process duration corresponding to the first process device according to the process state and a corresponding preset process duration of each of the process chambers;
taking a sum of all the third quantities as the second quantity corresponding to the second process device.

Optionally, the method also includes:
in a condition a quantity of the second process device is at least two, predicting a fourth quantity of target materials that can be treated by each second process device during the preset process duration corresponding to the first process device based on the current process state of each second process device;
controlling the feeding action to the first process device according to a sum of all the fourth quantities and the first quantity.

Optionally, controlling the feeding action to the first process device according to the first quantity and the second quantity includes:
when the first quantity is less than or equal to the second quantity, controlling feeding to the first process device;
or,
suspending feeding to the first process device when the first quantity is greater than the second quantity.

In a second aspect, an embodiment of the present disclosure further provides a production control apparatus, including:
an acquisition unit configured to acquire a first quantity of materials to be treated corresponding to first process device, wherein, the materials to be treated are target materials that have entered the first process device but have not entered second process device, and the second process device is a process device in a next procedure after the first process device;
a prediction unit configured to predict a second quantity of target materials that can be treated by the second process device during a preset process duration corresponding to the first process device based on a current process state of the second process device, wherein, the process state comprises a working state and a maintenance state, and the second process device can treat a fixed quantity of target materials in each working state;
a control unit configured to control a feeding action to the first process device according to the first quantity and the second quantity.

In a third aspect, an embodiment of the present disclosure further provides an electronic device including a memory and a memory storing a computer program executable on a processor, wherein the processor implements steps of the production control method in any of the above exemplary embodiments when the processor executes the computer program.

In a fourth aspect, an embodiment of the present disclosure further provides a non-transient computer-readable storage medium storing a computer program configured to implement the production control method in any of the above exemplary embodiments when executed.

Other features and advantages of the present disclosure will be set forth in the following specification, and moreover, partially become apparent from the specification, or are understood by implementing the present disclosure. Other advantages of the present disclosure may be achieved and obtained through solutions described in the specification and drawings.

Other aspects of the present disclosure may be comprehended after the drawings and the detailed descriptions are read and understood.

### BRIEF DESCRIPTION OF DRAWINGS

Various other advantages and benefits will become apparent to those having ordinary skill in the art after they read the following detailed description of exemplary embodiments. The drawings are for the purpose of illustrating exemplary embodiments only and are not considered a limitation of this specification. Furthermore, throughout the drawings, same elements are denoted by same reference symbols. In the drawings:

FIG. 1 is a schematic diagram of a flow of a production control method provided in an embodiment of the present disclosure;

FIG. 2 is a schematic diagram of a working condition provided in an embodiment of the present disclosure;

FIG. 3 is a schematic diagram of a structure of a process system provided in an embodiment of the present disclosure;

FIG. 4 is a schematic diagram of a structure of another process system provided in an embodiment of the present disclosure;

FIG. 5 is a schematic diagram of a structure of yet another process system provided in an embodiment of the present disclosure;

FIG. 6 is a schematic diagram of a production control effect provided in an embodiment of the present disclosure;

FIG. 7 is a production control device provided in an embodiment of the present disclosure;

FIG. 8 is a schematic diagram of a structure of an electronic device provided in an embodiment of the present disclosure;

FIG. 9 is a schematic diagram of a structure of a storage medium provided in an embodiment of the present disclosure.

### DETAILED DESCRIPTION

The terms “first,” “second,” “third,” “fourth,” etc. (if present) in the specification and claims of the present disclosure and the above drawings are used to distinguish similar objects and not necessarily used to describe a specific order or sequence. It should be understood that the data used in this way can be interchanged where appropriate so that the embodiments described herein can be implemented in an order other than that illustrated or described herein. Further, the terms “include” and “have” and any variations thereof are intended to cover non-exclusive inclusion, for example, processes, methods, systems, products, or devices that include a series of steps or units need not be limited to those clearly listed, but may include other steps or units that are not clearly listed or are inherent to such processes, methods, products, or devices. The technical schemes in the embodiments of present disclosure will be described clearly and completely with reference to the drawings in the embodiments of present disclosure. The described embodiments are apparently only part of the exemplary embodiments of the present disclosure, rather than all of the embodiments.

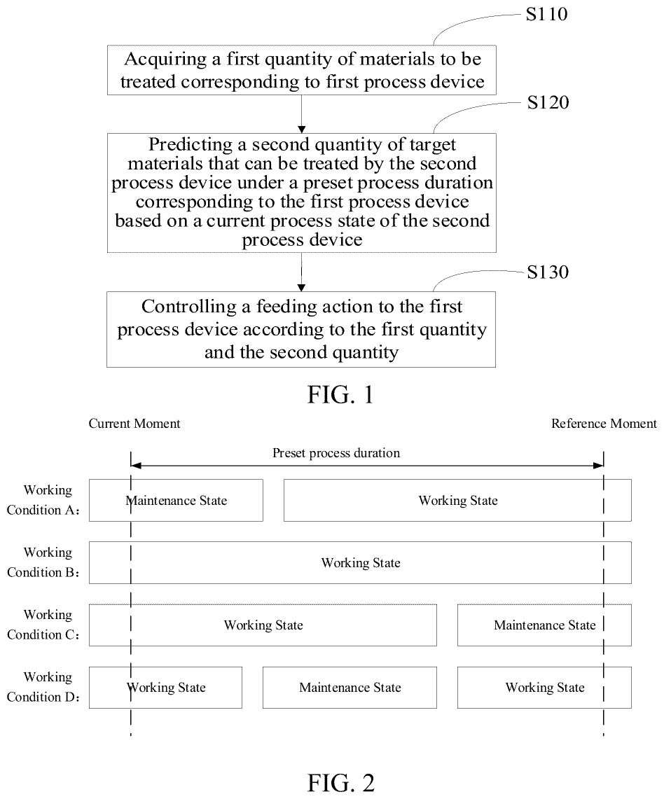

The embodiment of the disclosure provides a production control method. FIG. 1 is a schematic diagram of a flow of a production control method in an embodiment of the present disclosure. As shown in FIG. 1, the production control method may include acts of S110-S130.

In S110, a first quantity of materials to be treated corresponding to first process device is acquired, wherein the materials to be treated are target materials that have entered the first process device and have not entered the second process device, and the second process device is a process device in a next procedure after the first process device.

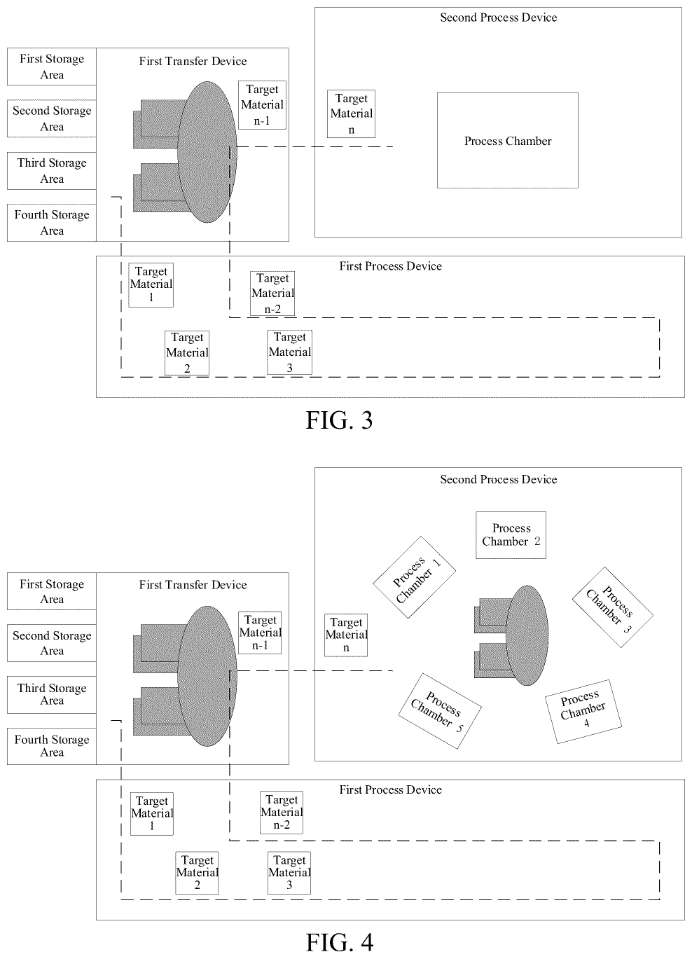

In an exemplary embodiment, FIG. 3 is a schematic diagram of a structure of a process system provided in an embodiment of the present disclosure, and the process system may include: a first process device, a first transfer device, and a second process device, wherein the first process device is configured to perform a first process treatment on the materials, the first transfer device is configured to transfer the materials treated by the first process device to the second process device, and the second process device is configured to perform a second process treatment on the treated materials.

Exemplarily, as shown in FIG. 3, the second process device is a process device in the next procedure after the first process device. For example, the first process device can be a heating device, which heats the target materials to a preset temperature and then quickly transfer them to the second process device for a process corresponding to the next procedure; or, the first process device may be a cleaning device, and after being cleaned by the first process device, the cleaned target materials are quickly put into the second process device to be performed with the treatment of second process.

When the target materials are not quickly put into the second process device after passing through the first process device, on the one hand, the target materials will accumulate in front of the second process device, on the other hand, it is easy to cause pollution to the target materials when the target materials cannot enter the second process device in time. For example, taking the first process device as the heating device as an example, the target materials treated by the heating device cannot enter the second process device in time, which may cause the temperature of the target materials not meeting the requirements when the target materials reach the second process device. For another example, taking the first process device as the cleaning device as an example, the target materials treated by the cleaning devices cannot enter the second process device in time, which may cause the cleanliness of the target materials not meeting the requirements or the surfaces of the target materials being corroded by the environment when the target materials reach the second process device, thus affecting the quality of the products.

In order to avoid undesirable problems such as accumulation of the target materials and pollution of the target materials, a first quantity of materials to be treated corresponding to the first process device can be acquired, and the materials to be treated are the target materials that have entered the first process device but have not entered the second process device. For example, the materials to be treated may include target materials being treated by the first process device, and may also include target materials that have been treated by the first process device but have not yet entered the second process device, i.e. target materials exposed to a workshop environment.

In S120, a second quantity of target materials that can be treated by the second process device during a preset process duration corresponding to the first process device is predicted based on a current process state of the second process device, wherein the process state may include a working state and a maintenance state.

Exemplarily, the current process state of the second process device may include a working state and a maintenance state, wherein the working state refers to a corresponding state when the second process device is executing the second process, and the maintenance state refers to a corresponding state when the second process device is unable to execute the second process.

Exemplarily the maintenance state may include a state of self-cleaning of an device or replacement of relevant vulnerable parts of an device and the like.

Exemplarily, the second process device may enter a maintenance state after processing a fixed quantity of target materials. Herein, the fixed quantity can be set according to an actual application situation, for example, the self-cleaning can be performed after the treatment of target materials for 5 pieces.

Exemplarily, the current process state may also include a time in the working state and a time in the maintenance state. The preset process duration corresponding to the first process device refers to a duration from entering the first process device to completing the first process and moving out of the first process device, such as a heating treatment duration or a cleaning treatment duration. The second quantity of target materials that can be treated during a corresponding process duration can be predicted according to the current process state of the second process device.

In S130, a feeding action to the first process device is controlled according to the first quantity and the second quantity.

Exemplarily, it is controlled to feed or stop feeding to the first process device according to the first quantity of materials to be treated corresponding to the first process device and the second quantity of target materials that can be treated by the second process device during the preset process duration, so that the first process device can provide enough target materials to the second process device, and it is ensured that no excessive target materials are located between the first process device and the second process device, thus avoiding material accumulation and material pollution.

Thus, the production control method provided in the embodiment of the present disclosure controls the feeding action to the first process device by acquiring the first quantity of the materials to be treated corresponding to the first process device and predicting the second quantity of the target material that can be treated by the second process device during the preset process duration corresponding to the first device according to the process state of the second device, and controlling the feeding action to the first process device through the second quantity and the first quantity. Thus, when the production rhythm of the second process device fluctuates due to a switching of the working state of the second process device, the feeding rhythm of the first process device in the previous procedure can be adjusted according to production fluctuation of the second process device in the subsequent procedure, thereby avoiding product blockage caused by the target materials in front of the second process device after exiting the first process device, avoiding pollution caused by the target materials, meeting a maximum production capacity of the second process device in the production line, and further achieving the purposes of intelligently controlling production, optimizing production rhythm and improving product quality.

In some exemplary embodiments, predicting the second quantity of target materials that can be treated by the second process device during the preset process duration corresponding to the first process device based on the current process state of the second process device may include:
determining a remaining process duration before maintenance based on a rated duration of a single piece process corresponding to the second process device, a remaining process capacity before maintenance and a processed duration of the current piece, wherein the remaining process capacity before maintenance is a maximum quantity of target materials that the second process device can continue to treat before entering the maintenance state;
determining a remaining duration before ending maintenance according to the rated duration of the single piece process corresponding to the second process device, the remaining process capacity before maintenance, the processed duration of the current piece and a rated duration of maintenance;
predicting the second quantity of target materials that can be treated by the second process device during the preset process duration corresponding to the first process device according to the remaining process capacity before maintenance, the remaining process duration before maintenance, the remaining duration before ending maintenance and the preset process duration.

Exemplarily, the second process device may enter the maintenance state after treating a fixed quantity of target materials, for example, taking a fixed quantity of 5 pieces as an example, the second process device may enter the maintenance state after completing a treatment of 5 pieces of target materials.

Exemplarily, the rated duration of the single-piece process corresponding to the second process device refers to a rated duration required for the second process device to treat a piece of target material, for example, the rated duration of the single-piece process for the second process device to treat a piece of target material may be 4 minutes.

For example, the remaining process capacity before maintenance corresponding to the second process device is the maximum quantity of target materials that the second process device can continue to treat before entering the maintenance state. For example, taking the above-mentioned fixed quantity of 5 pieces as an example, the second process device has completed the process treatment of 2 pieces of target materials, and at this time, the remaining process capacity before maintenance corresponding to the second process device is 3.

Exemplarily, the processed duration of the current piece corresponding to the second process device refers to a corresponding processed duration that the second process device may be treating a certain target material at the current time but has not finished the treatment, which may be, for example, 3 minutes.

Exemplarily, the rating duration of maintenance corresponding to the second process device refers to a time required for the second process device to complete a maintenance state, which may be set to, for example, 10 minutes.

Exemplarily, the preset process duration corresponding to the first process device refers to a time required for the first process device to perform the first process treatment on the target materials, which may be, for example, 12 minutes.

The time and quantity listed above are for illustrative purposes only and embodiments of the present disclosure do not limit actual values of the related parameters.

The remaining process duration before maintenance t1 can be calculated by equation (1):

$$t 1 = Cyc Remain * T ( Tacktime ) - ProcessTime ; \qquad ( 1 )$$

In the above equation (1), CycRemain is the remaining process capacity before maintenance corresponding to the second process device, T (Tacktime) is the rated duration of the single piece process corresponding to the second process device, and ProcessTime is the processed duration of the current piece corresponding to the second process device.

The remaining duration before ending maintenance t2 can be calculated by equation (2):

$$t 2 = Cyc Remain * T ( Tacktime ) + T ( selfClean ) - ProcessTime ; \qquad ( 2 )$$

In the above equation (2), CycRemain is the remaining process capability before maintenance corresponding to the second process device, T (Tacktime) is the rated duration of the single piece process corresponding to the second process device, ProcessTime is the processed duration of the current piece corresponding to the second process device, and T (selfClean) is the rating duration of maintenance corresponding to the second process device.

The second quantity of target materials that can be treated by the second process device during the preset process duration corresponding to the first process device is predicted according to the remaining process capacity before maintenance CycRemain, the remaining process duration before maintenance t1, the remaining duration before ending maintenance t2 and the preset process duration T(Transfer).

Thus, the production control method provided in the embodiment of the present disclosure includes according to the remaining process capacity before maintenance corresponding to the second process device, the remaining process duration before maintenance corresponding to the second process device, the remaining duration before ending maintenance corresponding to the second process device and the preset process duration corresponding to the first process device, predicting the second quantity of target materials that can be treated by the second process device during the preset process duration corresponding to the first process device, and can make accurate prediction for the second quantity of target materials that can be treated by the second process device under different working conditions within the preset process duration corresponding to the first process device, thereby more accurately controlling the feeding action to the first process device.

The following describes how to predict the second quantity of target materials that can be treated by the second process device during the preset process duration corresponding to the first process device, in view of the different working conditions of the second process device.

In some exemplary embodiments, reference is made to FIG. 2, which illustrates four working conditions corresponding to a second process device, including a working condition A, a working condition B, a working condition C, and a working condition D. The working condition A can refer to a working condition in which the remaining process capacity before maintenance corresponding to the second process device is equal to zero. The working condition B may refer to a working condition in which the remaining process capacity before maintenance corresponding to the second process device is not zero, and the remaining process duration before maintenance corresponding to the second process device is greater than the preset process duration corresponding to the first process device. The working condition C may refer to a working condition in which the remaining process capacity before maintenance corresponding to the second process device is not zero, the remaining process duration before maintenance corresponding to the second process device is less than the preset process duration corresponding to the first process device, and the remaining duration before ending maintenance corresponding to the second process device is greater than the preset process duration corresponding to the first process device. The working condition D may refer to a working condition in which the remaining process capacity before maintenance corresponding to the second process device is not zero, the remaining process duration before maintenance corresponding to the second process device is less than the preset process duration corresponding to the first process device, and the remaining duration before ending maintenance corresponding to the second process device is less than the preset process duration corresponding to the first process device.

In some exemplary embodiments, taking the second process device in the working condition A as an example, predicting the second quantity of target materials that can be treated by the second process device during the preset process duration corresponding to the first process device according to the remaining process capacity before maintenance, the remaining process duration before maintenance, the remaining duration before ending maintenance and the preset process duration may include: when the remaining process capacity before maintenance corresponding to the second process device is equal to zero, acquiring a maintained duration corresponding to the second process device; calculating the second quantity according to the preset process duration corresponding to the first process device, the rated duration of maintenance corresponding to the second process device, the maintained duration corresponding to the second process device and the rated duration of the single piece process corresponding to the second process device.

Exemplarily, the second process device is in a working condition A, indicating that the second process device corresponds to a working condition in which the remaining process capacity before maintenance is equal to zero, that is, CycRemain=0, and under this condition, the second process device enters the maintenance state. It can be acquired how long the second process device has been maintained, that is, the maintained duration corresponding to the second process device CleanTime can be acquired. And it can be determined when the maintenance of the second process device can be completed. The quantity of target materials can be calculated that be treated after the completion and within the preset process duration, that is, the second quantity N_{2A} corresponding to the working condition A. The second quantity N_{2A} can be calculated by equation (3):

$${N}_{2 A} = ( T ( Transfer ) - ( T ( selfClean ) - CleanTime ) ) / T ( Tacktime ) ; \qquad ( 3 )$$

In the above equation (3), T(Transfer) is the preset process duration corresponding to the first process device, T (selfClean) is the rated duration of maintenance corresponding to the second process device, T (selfClean) is the rated duration of maintenance corresponding to the second process device, T (Tacktime) is the rated duration of the single piece process corresponding to the second process device, CleanTime is the maintained duration corresponding to the second process device, and N_{2A} is the second quantity of target materials that can be treated by the second process device during the preset process duration corresponding to the first process device when the remaining process capacity before maintenance corresponding to the second process device is equal to zero.

In some exemplary embodiments, taking the second process device in the working condition B as an example, predicting the second quantity of target materials that can be treated by the second process device during the preset process duration corresponding to the first process device according to the remaining process capacity before maintenance, the remaining process duration before maintenance, the remaining duration before ending maintenance and the preset process duration may include: when the remaining process capacity before maintenance corresponding to the second process device is not zero and the remaining process duration before maintenance corresponding to the second process device is greater than the preset process duration corresponding to the first process device, determining the second quantity according to the preset process duration corresponding to the first process device, the rated duration of the single piece process corresponding to the second process device and the processed duration of the current piece corresponding to the second process device.

For example, the second process device is in the working condition B, indicating that the second process device corresponds to a working condition in which the remaining process capacity before maintenance is not zero and the remaining process duration before maintenance is greater than the preset process duration, that is, CycRemain≠0, t1>T(Transfer). Under this condition, the second process device will work all the time within the preset process duration and will not enter the maintenance state. The second quantity N_{2B} under the working condition B can be calculated by equation (4):

$${N}_{2 B} = ( T ( Transfer ) - ( T ( Tacktime ) - ProcessTime ) ) / T ( Tacktime ) ; \qquad ( 4 )$$

In the above equation (4), T(Transfer) is the preset process duration corresponding to the first process device, T (Tacktime) is the rated duration of the single piece process corresponding to the second process device, ProcessTime is the processed duration of the current piece corresponding to the second process device, and N_{2B} is the second quantity of target materials that can be treated by the second process device during the preset process duration corresponding to the first process device when the remaining process capacity before maintenance corresponding to the second process device is not zero and the remaining process duration before maintenance is greater than the preset process duration.

In some exemplary embodiments, taking the second process device in the working condition C as an example, predicting the second quantity of target materials that can be treated by the second process device during the preset process duration corresponding to the first process device according to the remaining process capacity before maintenance, the remaining process duration before maintenance, the remaining duration before ending maintenance and the preset process duration may include: when the remaining process capacity before maintenance corresponding to the second process device is not zero, the remaining process duration before maintenance corresponding to the second process device is less than the preset process duration corresponding to the first process device and the remaining duration before ending maintenance corresponding to the second process device is greater than the preset process duration corresponding to the first process device, determining that the remaining process capacity before maintenance corresponding to the second process device is the second quantity.

Exemplarily, the second process device is in the working condition C, indicating that the second process device corresponds to a working condition in which the remaining process capacity before maintenance is not zero, the remaining process duration before maintenance is less than the preset process duration and the remaining duration before ending maintenance is greater than the preset process duration, i.e. CycRemain≠0, t1<T(Transfer), and t2>T(Transfer). Under this condition, the second process device has not yet entered the maintenance state, but will enter the maintenance state within the preset process duration T(Transfer). Therefore, the remaining process capacity before maintenance CycRemain can be determined as the second quantity N_{2C} under the working condition C.

In some exemplary embodiments, taking the second process device in the working condition D as an example, predicting the second quantity of target materials that can be treated by the second process device during the preset process duration corresponding to the first process device according to the remaining process capacity before maintenance, the remaining process duration before maintenance, the remaining duration before ending maintenance and the preset process duration may include: when the remaining process capacity before maintenance corresponding to the second process device is not zero, the remaining process duration before maintenance corresponding to the second process device is less than the preset process duration corresponding to the first process device and the remaining duration before ending maintenance corresponding to the second process device is less than the preset process duration corresponding to the first process device, determining the second quantity according to the preset process duration corresponding to the first process device, the rated duration of the single piece process corresponding to the second process device, the processed duration of the current piece corresponding to the second process device and the rated duration of maintenance corresponding to the second process device.

Exemplarily, the second process device is in the working condition D, indicating that the second process device corresponds to a working condition in which the remaining process capacity before maintenance is not zero, the remaining process duration before maintenance is less than the preset process duration and the remaining duration before ending maintenance is less than the preset process duration, i.e. CycRemain≠0, t1<T(Transfer), and t2<T(Transfer). Under this condition, the second process device is not currently in the maintenance state, but will undergo a complete maintenance treatment within T(Transfer) duration. The second quantity N_{2D} under the working condition D can be calculated by equation (5):

$${N}_{2 D} = ( T ( Transfer ) - ( T ( Tacktime ) - ProcessTime ) - T ( selfClean ) ) / T ( Tacktime ) ; \qquad ( 5 )$$

In the above equation (5), T(Transfer) is the preset process duration corresponding to the first process device, T (Tacktime) is the rated duration of the single piece process corresponding to the second process device, ProcessTime is the processed duration of the current piece corresponding to the second process device, T (selfClean) is the rated duration of maintenance corresponding to the second process device and N_{2D} is the second quantity of target materials that can be treated by the second process device during the preset process duration corresponding to the first process device when the remaining process capacity before maintenance is not zero, the remaining process duration before maintenance is less than the preset process duration and the remaining duration before ending maintenance is less than the preset process duration.

Thus, the production control method provided in the embodiment of the present disclosure includes according to the remaining process capacity before maintenance corresponding to the second process device, the remaining process duration before maintenance corresponding to the second process device, the remaining duration before ending maintenance corresponding to the second process device and the preset process duration corresponding to the first process device, arranging four working conditions for the second process device and providing an exemplary implementation method for predicting the second quantity under each working condition, thereby realizing accurately controlling the predicted production capacity of the second process device under a plurality of conditions, and furthermore, more accurately controlling the feeding action to the first process device.

In an exemplary embodiment, the second process device may include a process chamber or a plurality of process chambers, such as two process chambers, three process chambers, four process chambers, five process chambers, etc. The embodiments of the present disclosure are not limited thereto.

In some exemplary embodiments, predicting the second quantity of target materials that can be treated by the second process device during the preset process duration corresponding to the first process device based on a current process state of the second process device may include:
when the second process device includes at least two process chambers, respectively acquiring a current process state of each chamber;
determining a third quantity of target materials that can be treated by each process chamber during the preset process duration corresponding to the first process device according to a process state of each process chamber and a corresponding preset process duration;
taking a sum of all the third quantities as the second quantity corresponding to the second process device.

In an exemplary embodiment, the second process device may include a plurality of process chambers, e.g. two process chambers, three process chambers, four process chambers, five process chambers, etc. Exemplarily, as shown in FIG. 4, taking the second process device including five process chambers as an example, the second process device includes a total of five process chambers from a process chamber 1 to a process chamber 5, each of which may correspond to a process state corresponding to any one of the working conditions A, B, C and D introduced in the above-mentioned embodiment. According to a current process state of each process chamber and the preset process duration corresponding to the first process device, determine a third quantity corresponding to each process chamber, which may include a third quantity N₃₁ corresponding to the process chamber 1, a third quantity N₃₂ corresponding to a process chamber 2, a third quantity N₃₃ corresponding to a process chamber 3, a third quantity N₃₄ corresponding to a process chamber 4 and a third quantity N₃₅ corresponding to the process chamber 5, and take N₃₁+N₃₂+N₃₃+N₃₄+N₃₅ as the second quantity N₂ corresponding to the second process device.

Thus, the production control method provided in the embodiment of the present disclosure includes when the second process device is a process device with a plurality of chambers, respectively acquiring a current working state of each chamber, determining a third quantity corresponding to each process chamber, i.e. an expected production capacity within the preset process duration, taking the sum of all the third quantities as the second quantity corresponding to the second process device, and controlling the feeding action to the first device according to a relationship between the second quantity and the first quantity, thus realizing an intelligent control production solution for the process device with the plurality of chambers.

In an exemplary embodiment, a quantity of second process devices may be one or more, for example, two, three, four, five, etc. The embodiments of the present disclosure are not limited thereto.

In some exemplary embodiments, the production control method may further include: when the quantity of the second process device is at least two, predicting a fourth quantity of target materials that can be treated by each of the second process devices during the preset process duration corresponding to the first process device, respectively, based on the current process state of each of the second process devices; controlling the feeding action to the first process device according to a sum of all the fourth quantities and the first quantity.

In an exemplary embodiment, a first process device may correspond to a plurality of second process devices. For example, a first process device may correspond to two second process devices, a first process device may correspond to three second process devices, or a first process device may correspond to three second process devices, etc. The embodiments of the present disclosure are not limited thereto.

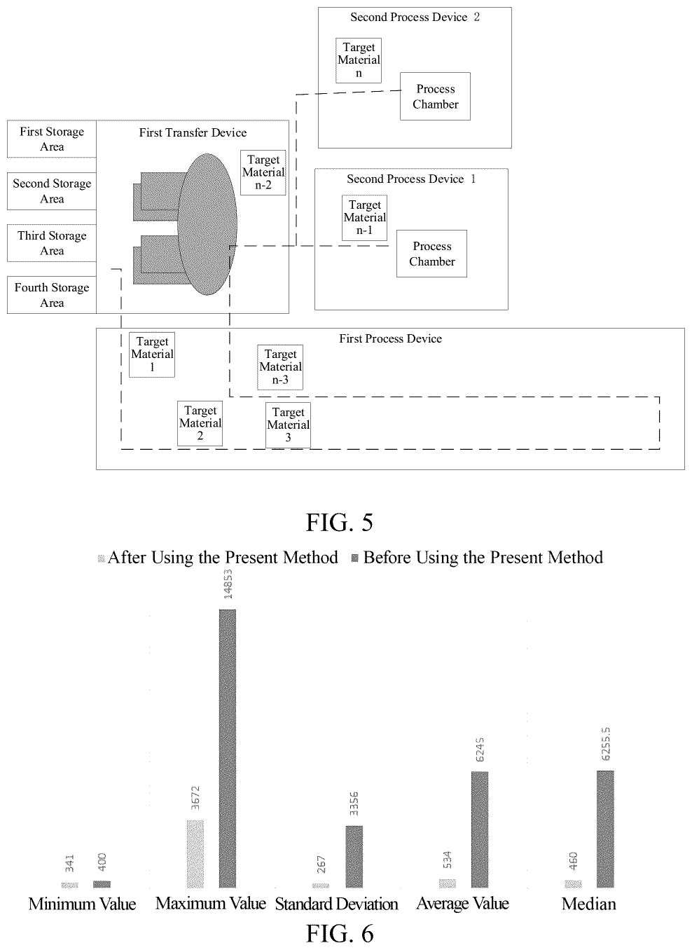

Exemplarily, as shown in FIG. 5, taking a first process device corresponding to two second process devices as an example, a first process device can correspond a second process device 1 and a second process device 2. A fourth quantity of target materials that can be treated by each second process device during a preset process duration corresponding to the first process device is predicted according to a process state of each second process device, which may include: a fourth quantity N₄₁ corresponding to the second process device 1 and a fourth quantity N₄₂ corresponding to the second process device 2. The feeding action of the first process device is controlled according to the first quantity and a sum of all the fourth quantities (e.g. N₄₁+N₄₂).

In some exemplary embodiments, controlling the feeding action to the first process device according to the first quantity and a sum of all the fourth quantities may include: controlling feeding to the first process device when the first quantity is less than or equal to a sum of all the fourth quantities; or, when the first quantity is greater than the sum of all the fourth quantities, suspending feeding to the first process device.

Exemplarily, when the first quantity is less than or equal to the sum of all the fourth quantities, the target materials treated by the first process device is insufficient for at least one of a plurality of second process devices to work continuously, which can easily cause the plurality of second process devices to Idle, and thus it is necessary to control the feeding to the first process device to provide sufficient target materials; when the first quantity is greater than the sum of all the fourth quantities, the target materials may cause product blockage between the first process device and at least one of the plurality of second process devices, and thus it is necessary to control to stop feeding to the first process device to avoid aggravation of blockage and relieve working pressure of the second process devices.

Thus, the production control method provided in the embodiment of the present disclosure includes a first process device corresponding to a plurality of second process device by predicting a fourth quantity of target materials that can be treated by each of the second process devices during a preset process duration corresponding to the first process device, and controlling the feeding action to the first device according to a relationship between the sum of all the fourth quantities and the first quantity, thereby realizing a more intelligent production method when a first process device corresponds to a plurality of second process devices.

In some exemplary embodiments, controlling the feeding action to the first process device according to the first quantity and the second quantity may include: when the first quantity is less than or equal to the second quantity, controlling feeding to the first process device; or, when the first quantity is greater than the second quantity, suspending feeding to the first process device.

Exemplarily, when the first quantity is less than or equal to the second quantity, the target material treated by the first process device is insufficient for the second process devices to work continuously, which easily causes the second process devices to Idle, and it is necessary to control feeding to the first process device to provide sufficient target materials; when the first quantity is greater than the second quantity, the target materials may cause product blockage between the second process devices and the first process device, and thus it is necessary to control to stop feeding to the first process device to avoid aggravation of blockage and relieve working pressure of the second process devices.

The production control method provided by the embodiment of the present disclosure can effectively control the feeding device of the first process device according to a relationship between the first quantity and the second quantity, can ensure that the second process device has enough target materials for production to avoid idle, and can avoid product blockage between the first process device and the second process devices, thereby providing a more intelligent production control method.

In some exemplary embodiments, the process state of the second process device may also include a failure state.

In some exemplary embodiments, the production control method may further include storing the target materials exited from the first process device in a temporary storage area when the process state is a failure state and the first quantity is greater than the second quantity.

Exemplarily, the second process device may also have a local failure, resulting in a decrease in production capacity. Under such condition, the second process device cannot immediately treat the target materials treated by the first process device, and the target materials can be stored in the temporary storage area to avoid disorderly accumulation of the target materials.

Thus, the production control method provided in the embodiment of the present disclosure includes when the second process device has a failure, in order to avoid disorderly accumulation of the target materials, putting the target materials treated by the first process device into the temporary storage area for storage, thus providing a standby solution when the process device has the failure.

In some exemplary embodiments, CVD (Chemical Vapor Deposition) chamber-type process device self-cleans after process treating certain products, so the production rhythm of the second process device will fluctuate. When it is self-cleaning, the production rhythm will be slower. Before the CVD process, it is necessary to carry out cleaning a section of side lap of device for the process. However, a production rhythm of a cleaning machine is constant, which will cause a phenomenon of production blockage in the cleaning machine when a chamber device is self-cleaned. Production blockage will cause capacity loss and yield loss in the cleaning machine process. When Glass is blocked in the cleaning machine, it will enter the Buffer of the cleaning machine. At this time, the cleaning machine needs to produce all the Glass undergoing process treatment before continuing to feed Glass for production, which leads to an interruption of the process and a long cleaning duration, and wastes production time; Glass failed to feed into CVD chamber type process device in time after the production of the cleaning machine, and long-term exposure to acidic environment easily led to other abnormal production problems, resulting in poor products (often manifested as electrical abnormalities).

As an example, in the process system shown in FIG. 4, the second process device may be a CVD chamber type process device, the first process device may be a cleaning machine for pretreatment thereof, and the target material may be a Glass for process treatment. Glass in the temporary storage area can be fed into the cleaning machine for cleaning process treatment by a first transfer device (such as robot), and the Glass treated by the cleaning machine can be fed into the CVD chamber type process device for PECVD (Plasma Enhanced Chemical Vapor Deposition) process treatment after the Glass is cleaned by the cleaning machine. The cleaned Glass needs to be quickly sent into the CVD chamber type process device after the Glass is treated by the cleaning machine to avoid a pollution of particles to the Glass. And each chamber of the CVD chamber type device will be self-cleaned after a fixed quantity of processes, resulting in the CVD chamber type device becoming a bottleneck device, although the capacity of the cleaning machine can completely meet capacity requirements of CVD chamber type device, the Glass fed into cleaning machine needs a long time to flow into CVD chamber type device. When Glass is produced from cleaning machine, the CVD chamber type device may have completed several processes. That is to say, all Glass fed into the cleaning machine needs to be calculated and predicted to coordinate the production rhythm between the cleaning machine and the CVD chamber type device.

In order to automatically balance a production rhythm, a correlation between the cleaning machines and the CVD chamber type device can be found. If we consider Glass flow as water flow, then each chamber in the CVD chamber type device is like a channel of water flow. No matter how big each channel is, the total amount of water flow in each channel per unit time is the same in the end. For Glass, this total amount is an expected capacity of the CVD chamber type device within the preset process duration. How to link the capacity of the cleaning machine and the CVD chamber type device is a key point of data control production. Initial setting goal: Glass fed from the cleaning machine can just enter a certain chamber of the CVD chamber type device when it is produced, that is, Glass after cleaning can enter a certain chamber. Then a time period of expected capacity correlation can be determined: a time required for Glass from feeding to outputting and entering the chamber of CVD chamber type device is T(Transfer). By refining the correlation of production capacity to Glass, the purpose of controlling the production rhythm can be achieved by controlling the feed rhythm of the cleaning machine. When fed into the line body, the quantity of Glass sheets SUM (the quantity of existing Glass in the line body, that is, the first quantity) that has not entered the chamber of the CVD chamber type device is taken as a capacity correlation point, then the quantity of Glass sheets SUM that can be produced according to the capacity of the CVD chamber type device (the demand of the CVD chamber type device, that is, the second quantity) is the maximum quantity allowed to be fed into the cleaning machine from the current time point during a future T(Transfer) time period. That is to say, N₁ (the quantity of existing Glass in the line body, that is, the first quantity)≤N₂ (CVD demand, that is, the second quantity) needs to be met when feeding Glass into the line.

In some exemplary embodiments, the maximum quantity of Glass that the CVD chamber type device can continuously treat is 5. A rated duration of a single piece process T (Tacktime) is 4 minutes. A rated duration of maintenance T (selfClean) is 10 minutes, the maintenance state being the self-cleaning state of the CVD chamber type device. The preset process duration T(Transfer) is 12 minutes, i.e. the minimum time from entering a cleaning to entering a Glass of the CVD chamber type device is 12 minutes. Some states of the CVD chamber type device can be shown in Table 1:

TABLE 1

| | | CycRemain | | | t1 | t2 | |
|---|---|---|---|---|---|---|---|
| | | (Remaining | | ProcessTime | (Remaining | (Remaining | |
| | | Process | | (Processed | Process | Duration | |
| | | Capacity | CleanTime | Duration of | Duration | before | Second |
| | | before | (Maintained | The Current | before | Ending | Quantity |
| Chamber | State | Maintenance) | Duration) | Piece) | Maintenance) | Maintenance) | N₂ₓ(Rounded) |
| 1 | IDLE/ | 2 | / | 1 | 2*4 − 1 = 7 | 2*4 + 10 − 1 = 17 | working |
| | RUN | | | | | | condition C: |
| | | | | | | | N₂₁ = 2 |
| 2 | PM/ | 5/4/3/2/1 | / | / | / | / | / |
| | BM | | | | | | |
| 3 | IDLE/ | 4 | / | 2 | 4*4 − 2 = 14 | 4*4 + 10 − 2 = 24 | working |
| | RUN | | | | | | condition B: |
| | | | | | | | (2 − (4 − 2))/4 = 2 |
| 4 | IDLE/ | 1 | / | 3.5 | 1*4 − 3.5 = 0.5 | 1*4 + 10 − 3.5 = 10.5 | working |
| | RUN | | | | | | condition D: |
| | | | | | | | (12 − (4 − 3.5) − 10)/4 = 0 |
| 5 | IDLE/ | 0 | 7 | 0 | 0*4 − 0 = 0 | 0*4 + 10 − 0 = 10 | working |
| | RUN | | | | | | condition A: |
| | | | | | | | (12 − (10 − 7))/4 = 2 |

Through the production control method introduced in the above embodiment, it can be calculated that the chamber 1 corresponds to N₂₁=2 and the chamber 3 corresponds to N₂₃=2; Chamber 4 corresponds to N₂₄=0; Chamber 5 corresponds to N₂₅=2; Chamber 2 is in PM (Preventive Maintenance)/BM (Broken Machine) and does not participate in the calculation. Under this condition, N₂=2+2+0+2=6, that is, if we want to ensure the continuous process of CVD chamber type device and no product blockage, a relationship between N₁ and 6 should be judged, and when N₁ is less than 6, Glass is controlled to be fed into the cleaning machine; or, when N₁ is greater than or equal to 6, stop feeding Glass into the cleaning machine.

After using the production control method provided in the embodiment of the present disclosure, Glass no longer enters the Buffer (Buffer) of the cleaning machine, and the phenomenon that the cleaning line of the cleaning machine leads to the Idle of a main process CVD chamber type device no longer occurs. The production rhythm TT is reduced from 110 s to 92 s, with an overall increase of 18 s. By analyzing a time difference between Glass feeding into the cleaning machine and starting the CVD process, as described in FIG. 6, the ordinate corresponds to the production rhythm time(s), and the abscissa corresponds to five groups of statistical production rhythm data, namely a minimum value, a maximum value, a standard deviation, a average value and a median. It can be seen that the production control method provided in the embodiment of the present disclosure has obvious effect on balanced production, and the fed Glass can carry out the main process in time after being cleaned. The abnormal max maximum data is due to the device is in Down in part of the period. In the absence of production balance control, Glass may wait for a long time to carry out the main process after cleaning. The data in FIG. 6 are acquired from two systems of the same process type. The inventor of the present disclosure adopts the production control method provided in the embodiment of the present disclosure in one of the systems, while the other system does not use the method. It can be seen from the data that the production control method provided in the embodiment of the present disclosure can give full play to the production capacity of the CVD chamber type device, avoid IDLE, effectively prevent Buffer generation of the cleaning machine, optimize production efficiency and ensure production quality.

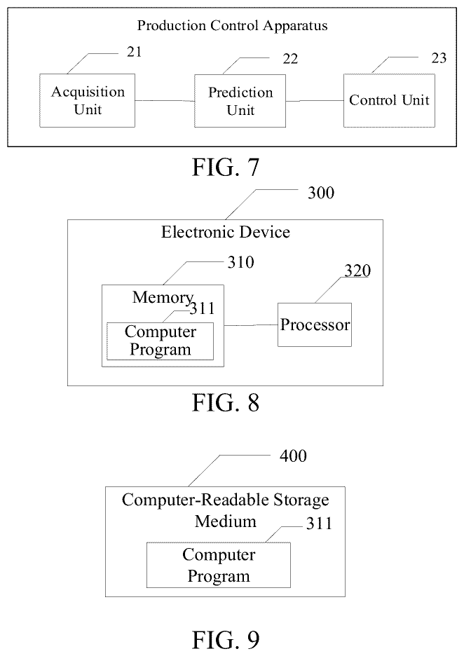

As shown in FIG. 7, the embodiment of the present disclosure also provides a production control device, which may include:
an acquisition unit 21 configured to acquire a first quantity of materials to be treated corresponding to a first process device, wherein the materials to be treated are target materials that have entered the first process device but has not entered a second process device, and the second process device is a process device in a next procedure after the first process device;
a prediction unit 22 configured to predict a second quantity of target materials that the second process device can process during a preset process duration corresponding to the first process device based on a current process state of the second process device, wherein the process state comprises a working state and a maintenance state.

For example, the second process device can process a fixed quantity of target materials in each working state.

A Control Unit 23 is configured to control a feeding action to the first process device according to the first quantity and the second quantity.

As shown in FIG. 8, an embodiment of the present disclosure also provides an electronic device 300 that may include a memory 310, a processor 320, and a computer program 311 stored on the memory 320 and executable on the processor 320, the processor 320 implementing the steps of the production control method in one or more of the above-described exemplary embodiments when executing the computer program 311.

As shown in FIG. 9, an embodiment of the present disclosure also provides a non-transient computer-readable storage medium 400 having stored thereon a computer program 311 configured to perform the production control method in one or more of the above-described exemplary embodiments.

Since the electronic device introduced in the embodiment is the device adopted for implementing a production control device in the embodiment of the disclosure, based on the method introduced in the embodiment of the disclosure, the technical personnel in the field can understand the specific implementation mode of the electronic device of the embodiment and various variations thereof, and how the electronic device realizes the method in the embodiment of the disclosure is not described in detail here, as long as the device adopted by the technical personnel in the field for implementing the method in the embodiment of the disclosure belongs to the scope intended to be protected by the disclosure.

In some exemplary implementations, the computer program 311 is configured to implement any of the embodiments corresponding to FIG. 1 when executed.

In the above-described embodiments, the description of different embodiments has different emphasis and parts of one embodiment that are not described in detail can be referred to the related descriptions of other embodiments.

It should be understood by those skilled in the art that the embodiments of the present disclosure may be provided as methods, systems, or computer program products. Therefore, for the present disclosure a form of an entire hardware embodiment, an entire software embodiment, or an embodiment combining software and hardware aspects may be adopted. Furthermore, for the present disclosure, a form of a computer program product implemented on one or more computer usable memory media (including but not limited to a magnetic disk memory, a Compact Disc Read Only Memory (CD-ROM), and an optical memory, etc.) containing computer usable program codes therein may be adopted.

The present disclosure is described with reference to flowcharts and/or block diagrams of methods, devices (systems), and computer program products according to the embodiments of the present disclosure. It should be understood that each flow and/or block in the flowcharts and/or block diagrams, as well as combinations of flows and/or blocks in the flowcharts and/or block diagrams, may be implemented by computer program instructions. These computer program instructions may be provided to a general purpose computer, a special purpose computer, an embedded computer, or a processor of another programmable data processing device, so that an apparatus configured to implement functions specified in one or more flows of the flowcharts and/or one or more blocks of the block diagrams through instructions executed by a computer or a processor of another programmable data processing device is generated.

These computer program instructions may also be stored in a computer-readable memory capable of directing a computer or another programmable data processing device to operate in a specific manner such that the instructions stored in the computer-readable memory produce an article of manufacture including an instruction apparatus, and the instruction apparatus implements functions specified in one or more flows of the flowcharts and/or one or more blocks of the block diagrams.

These computer program instructions may also be loaded onto a computer or another programmable data processing device such that a series of operational acts are executed on the computer or another programmable device to produce computer-implemented processing, such that the instructions executed on the computer or another programmable device provide acts for implementing functions specified in one or more flows of the flowcharts and/or one or more blocks of the block diagrams.

Embodiments of the present disclosure also provide a computer program product comprising computer software instructions that, when run on a processing device, cause the processing device to execute a flow of the production control method as in a embodiment corresponding to FIG. 1.

The computer program product includes one or more computer instructions. When computer program instructions are loaded and executed on a computer, processes or functions according to the embodiments of the present disclosure are generated in whole or in part. The computer may be a general-purpose computer, a special-purpose computer, a computer network, or another programmable apparatus. Computer instructions may be stored in a computer-readable storage medium, or transmitted from a computer-readable storage medium to another computer-readable storage medium. For example, computer instructions may be transmitted from a Web site, a computer, a server, or a data center via wired (e.g. coaxial cables, optical fibers, digital subscriber lines (DSLs)) or wireless (e.g. infrared, wireless, microwave, etc.) to another Web site, another computer, another server, or another data center. The computer-readable storage medium may be any available medium that a computer can store or a data storage device such as a server, data center, etc. that contains one or more available media integration. Available medium may be magnetic medium (e.g. floppy disk, hard disk, magnetic tape), optical medium (e.g. DVD), or semiconductor medium (e.g. solid state disk (SSD)), etc.

Those skilled in the art can clearly know that specific working processes of the system, apparatus and units described above may refer to the corresponding processes in the above method embodiments and will not be repeated herein for the ease and brevity of description.

In the embodiments provided in the present disclosure, it is to be understood that the disclosed system, apparatus and method may be implemented in other ways. For example, the apparatus embodiment described above is only schematic. For example, the division of each unit is only logical function division, and there may be other division ways in practical implementation. For example, multiple units or components may be combined or integrated into another system, or some features may be omitted or not executed. In addition, the coupling or direct coupling or communication connection between each other displayed or discussed may be indirect coupling or communication connection between apparatuses or units via some interfaces, and may be electrical, mechanical or in other forms.

The units described as separate parts may be or may be not physically separated. The parts displayed as units may be or may be not physical units. That is, the parts may be in the same location, or may be distributed on multiple network units. Part or all of the units may be selected according to an actual need to achieve the objective of the solution of the embodiment.

In addition, various functional units in various embodiments of the present disclosure may be integrated in a processing unit, or each unit may physically exist separately, or two or more units may be integrated in a unit. The integrated unit may be implemented in a form of hardware, or may be implemented in a form of a software functional unit.

Integrated units, if implemented in a form of software functional units and when being sold or used as independent products, may be stored in a computer-readable storage medium. Based on such an understanding, the technical scheme of the present disclosure in essence or the part making a contribution to the prior art or all or part of the technical solution may be embodied in form of a software product. The computer software product is stored in a storage medium containing a number of instructions for enabling a computer device (which may be a personal computer, a server, a network device or the like) to execute all or part of the steps of the method in each embodiment of the present disclosure. The aforementioned storage medium includes various media, such as a U disk, a mobile hard disk, a Read Only Memory (ROM), a Random Access Memory (RAM), a magnetic disk, or an optical disk, which are capable of storing program codes.

The above embodiments are only used to illustrate the technical scheme of the present disclosure, but not to limit it; although the present disclosure has been described in detail with reference to the foregoing embodiments, it should be understood by those of ordinary skill in the art that the technical scheme described in the foregoing respective embodiments can still be modified or some technical features thereof can be equivalently replaced; these modifications or substitutions do not depart from the spirit and scope of the respective embodiments of the present disclosure.

1. A production control method comprising:
acquiring a first quantity of materials to be treated corresponding to a first process device, wherein the materials to be treated are target materials that have entered the first process device but have not entered a second process device, and the second process device is a process device in a next procedure after the first process device;
predicting a second quantity of target materials that can be treated by the second process device during a preset process duration corresponding to the first process device based on a current process state of the second process device, wherein the process state comprises a working state and a maintenance state;
controlling a feeding action to the first process device according to the first quantity and the second quantity.

2. The method according to claim 1, wherein predicting the second quantity of target materials that can be treated by the second process device during the preset process duration corresponding to the first process device based on the current process state of the second process device comprises:
determining a remaining process duration before maintenance based on a rated duration of a single piece process, a remaining process capacity before maintenance and a processed duration of a current piece corresponding to the second process device, wherein the remaining process capacity before maintenance is a maximum quantity of target materials that the second process device can continue to treat before entering the maintenance state;
determining a remaining duration before ending maintenance according to the rated duration of the single piece process corresponding to the second process device, the remaining process capacity before maintenance, the processed duration of the current piece and a rated duration of maintenance;
predicting the second quantity of target materials that can be treated by the second process device during the preset process duration corresponding to the first process device according to the remaining process capacity before maintenance, the remaining process duration before maintenance, the remaining duration before ending maintenance and the preset process duration.

3. The method according to claim 2, wherein predicting the second quantity of target materials that can be treated by the second process device during the preset process duration corresponding to the first process device according to the remaining process capacity before maintenance, the remaining process duration before maintenance, the remaining duration before ending maintenance and the preset process duration comprises:
when the remaining process capacity before maintenance is equal to zero, acquiring a maintained duration corresponding to the second process device;
calculating the second quantity according to the preset process duration, the rated duration of maintenance, the maintained duration and the rated duration of the single piece process.

4. The method according to claim 2, wherein predicting the second quantity of target materials that can be treated by the second process device during the preset process duration corresponding to the first process device according to the remaining process capacity before maintenance, the remaining process duration before maintenance, the remaining duration before ending maintenance and the preset process duration comprises:
when the remaining process capacity before maintenance is not zero and the remaining process duration before maintenance is greater than the preset process duration, determining the second quantity according to the preset process duration, the rated duration of the single piece process and the processed duration of the current piece.

5. The method according to claim 2, wherein predicting the second quantity of target materials that can be treated by the second process device during the preset process duration corresponding to the first process device according to the remaining process capacity before maintenance, the remaining process duration before maintenance, the remaining duration before ending maintenance and the preset process duration comprises:
when the remaining process capacity before maintenance is not zero, the remaining process duration before maintenance is less than the preset process duration and the remaining duration before ending maintenance is greater than the preset process duration, determining that the remaining process capacity before maintenance is the second quantity.

6. The method according to claim 2, wherein predicting the second quantity of target materials that can be treated by the second process device during the preset process duration corresponding to the first process device according to the remaining process capacity before maintenance, the remaining process duration before maintenance, the remaining duration before ending maintenance and the preset process duration comprises:
when the remaining process capacity before maintenance is not zero, the remaining process duration before maintenance is less than the preset process duration and the remaining duration before ending maintenance is less than the preset process duration, determining the second quantity according to the preset process duration, the rated duration of the single piece process, the processed duration of the current piece and the rated duration of maintenance.

7. The method according to claim 1, wherein predicting the second quantity of target materials that can be treated by the second process device during the preset process duration corresponding to the first process device based on the current process state of the second process device comprises:
when the second process device comprises at least two process chambers, respectively acquiring an current process state of each chamber;
determining a third quantity of target materials that can be treated by each of the process chambers during the preset process duration corresponding to the first process device according to the process state and a corresponding preset process duration of each of the process chambers;
taking a sum of all the third quantities as the second quantity corresponding to the second process device.

8. The method according to claim 1, further comprising:
in a condition a quantity of the second process device is at least two, predicting a fourth quantity of target materials that can be treated by each second process device during the preset process duration corresponding to the first process device based on the current process state of each second process device, respectively;
controlling the feeding action to the first process device according to a sum of all the fourth quantities and the first quantity.

9. The method according to claim 1, wherein controlling the feeding action to the first process device according to the first quantity and the second quantity comprises:
when the first quantity is less than or equal to the second quantity, controlling feeding to the first process device;
or,
when the first quantity is greater than the second quantity, suspending feeding to the first process device.

10. A production control apparatus, comprising:
an acquisition unit configured to acquire a first quantity of materials to be treated corresponding to first process device, wherein the materials to be treated are target materials that have entered the first process device but have not entered a second process device, and the second process device is a process device in a next procedure after the first process device;
a prediction unit configured to predict a second quantity of target materials that can be treated by the second process device during a preset process duration corresponding to the first process device based on a current process state of the second process device, wherein the process state comprises a working state and a maintenance state;
a control unit configured to control a feeding action to the first process device according to the first quantity and the second quantity.

11. An electronic device, comprising: a processor and a memory storing a computer program that is runnable on the processor, wherein acts of the production control method according to claim 1 are implemented when the processor executes the computer program.

12. A non-transitory computer readable storage medium, storing a computer program configured to perform the production control method according to claim 1.
